(19) United States
(12) Patent Application Publication
(10) Pub. No.: US 2012/0043015 A1
(43) Pub. Date: Feb. 23, 2012

(54) METHOD AND APPARATUS FOR PROTECTING AN ELECTRONIC DEVICE

(76) Inventor: Kirk Feller, Bluffdale, UT (US)

(21) Appl. No.: 13/186,716

(22) Filed: Jul. 20, 2011

Related U.S. Application Data
(60) Provisional application No. 61/366,040, filed on Jul. 20, 2010.

(51) Int. Cl. B32B 38/10; B32B 37/14; B32B 37/12

(52) U.S. Cl. 156/247

(57) ABSTRACT

A method and apparatus for protecting an electronic device is disclosed and described. The apparatus can include a protective film having an adhesive disposed thereon. The protective film can be applied to the electronic device and secured with the adhesive. The adhesive can permit removing and repositioning of the protective film on the electronic device without leaving an adhesive residue on the device. Both the protective film and adhesive can be optically clear to allow visibility through the protective film to the underlying electronic device. When removed and/or repositioned on the electronic device, the protective film and adhesive can maintain optical clarity. Furthermore, the protective film can be removable from the electronic device without deforming, which can serve to maintain optical clarity.

### RELATED APPLICATION

This application claims the benefit of U.S. Provisional Patent Application No. 61/366,040, filed Jul. 20, 2010 which is incorporated herein by reference.

### FIELD OF THE INVENTION

The present invention relates generally to protective films and, more particularly, to protective films for electronic devices.

### BACKGROUND

Portable electronic devices, or mobile devices, have become prevalent in today's society. Frequently, users of electronic devices subject the devices to conditions or environments that can result in damage to the devices. Additionally, in the course of use, many devices are dropped, kicked, thrown, bitten, etc. Meanwhile, electronic devices may not be designed to withstand such use, which can result in damage to the devices. For example, touch screen technology is becoming increasingly common in today's electronic devices. Touch screens are routinely exposed and vulnerable to scratches, impacts, etc. Protective films can provide protection for an electronic device under a wide variety of potentially harmful conditions while, at the same time, being unobtrusive to use of the device. However, such films are often applied in a permanent manner such that removal of the film for repositioning or realignment results in reduced effectiveness or destruction of the film. For example, the film may become deformed or lose optical clarity when removed from a device or the adhesive may not provide an effective bond once removed from the device. For these and other reasons, it is desirable to provide protection for electronic devices with a protective film while allowing removal and repositioning of the film without rendering the film less effective or inoperable such as by deformation of the film or lack of adhesion to the electronic device.

### SUMMARY

A method and apparatus for protecting an electronic device is disclosed and described. The apparatus can include a protective film having an adhesive disposed thereon. The protective film can be applied to the electronic device and secured with the adhesive. The adhesive can permit removing and repositioning of the protective film on the electronic device without leaving an adhesive residue on the device. Both the protective film and adhesive can be optically clear to allow visibility through the protective film to the underlying electronic device. When removed and/or repositioned on the electronic device, the protective film and adhesive can maintain optical clarity. Furthermore, the protective film can be removable from the electronic device without deforming, which can serve to maintain optical clarity.

In one aspect, a method for applying protective film to a device is provided. The method can comprise receiving a protective film having an adhesive disposed thereon and a backing covering the adhesive, wherein the backing comprises a cut out in order for a portion of the backing to be removed from the protective film while maintaining a remaining portion of the backing on the protective film. The method can also comprise removing a smaller portion of the backing to expose adhesive of a first portion of the protective film. The method can further comprise aligning the protective film on the device. Still further, the method can comprise applying the first portion of the protective film to the device after the protective film is properly aligned. Additionally, the method can comprise flipping the remaining portion of the backing onto the applied portion of the protective film. The method can also comprise applying the remaining portion of the protective film by moving a squeegee across the device. The method can further comprise removing the remaining portion of the backing to expose the adhesive as the remaining protective film is applied to the device with the squeegee.

In one aspect, the method for applying protective film to a device can further comprise removing the protective film from the device. In another aspect, the method can further comprise realigning the protective film on the device and reapplying the protective film to the device.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

Features and advantages of the invention will be apparent from the detailed description that follows, and which taken in conjunction with the accompanying drawings, together illustrate features of the invention. It is understood that these drawings merely depict exemplary embodiments and are not, therefore, to be considered limiting of its scope. And furthermore, it will be readily appreciated that the components, as generally described and illustrated in the figures herein, could be arranged and designed in a wide variety of different configurations.

FIG. 1 is a protective film and a device, in accordance with an example of the present disclosure.

FIG. 2 is a cross-section of a protective film, in accordance with an example of the present disclosure.

FIG. 3 is a cross-section of a protective film, in accordance with another example of the present disclosure.

FIG. 4 is a schematic diagram of a method for applying protective film to a device, in accordance with an example of the present disclosure.

### DETAILED DESCRIPTION

Reference will now be made to exemplary embodiments and specific language will be used herein to describe the same. It will nevertheless be understood that no limitation of the scope of the present invention is thereby intended. Alterations and further modifications of the inventive features described herein, and additional applications of the principles of the invention as described herein, which would occur to one skilled in the relevant art and having possession of this disclosure, are to be considered within the scope of the invention. Further, before particular embodiments are disclosed and described, it is to be understood that this invention is not limited to the particular process and materials disclosed herein as such may vary to some degree. It is also to be understood that the terminology used herein is used for the purpose of describing particular embodiments only and is not intended to be limiting, as the scope of the present invention will be defined only by the appended claims and equivalents thereof.

It must be noted that, as used in this specification and the appended claims, the singular forms “a,” “an,” and “the” include plural referents unless the context clearly dictates otherwise. Thus, for example, reference to “a protective film” includes one or more of such protective films and reference to “a cut out” includes reference to one or more of such cut outs.

In describing and claiming the present invention, the following terminology will be used in accordance with the definitions set forth below.

As used herein, “substantial” when used in reference to a quantity or amount of a material, or a specific characteristic thereof, refers to an amount that is sufficient to provide an effect that the material or characteristic was intended to provide. The exact degree of deviation allowable may in some cases depend on the specific context. Similarly, “substantially free of” or the like refers to the lack of an identified element or agent in a composition. Particularly, elements that are identified as being “substantially free of” are either completely absent from the composition, or are included only in amounts which are small enough so as to have no measurable effect on the composition.

As used herein, “about” refers to a degree of deviation based on experimental error typical for the particular property identified. The latitude provided the term “about” will depend on the specific context and particular property and can be readily discerned by those skilled in the art. The term “about” is not intended to either expand or limit the degree of equivalents which may otherwise be afforded a particular value. Further, unless otherwise stated, the term “about” shall expressly include “exactly,” consistent with the discussion below regarding ranges and numerical data.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context.

Concentrations, dimensions, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a range of about 1 to about 200 should be interpreted to include not only the explicitly recited limits of 1 and 200, but also to include individual sizes such as 2, 3, 4, and sub-ranges such as 10 to 50, 20 to 100, etc.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Any steps recited in any method or process claims may be executed in any order and are not limited to the order presented in the claims unless otherwise stated. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given herein.

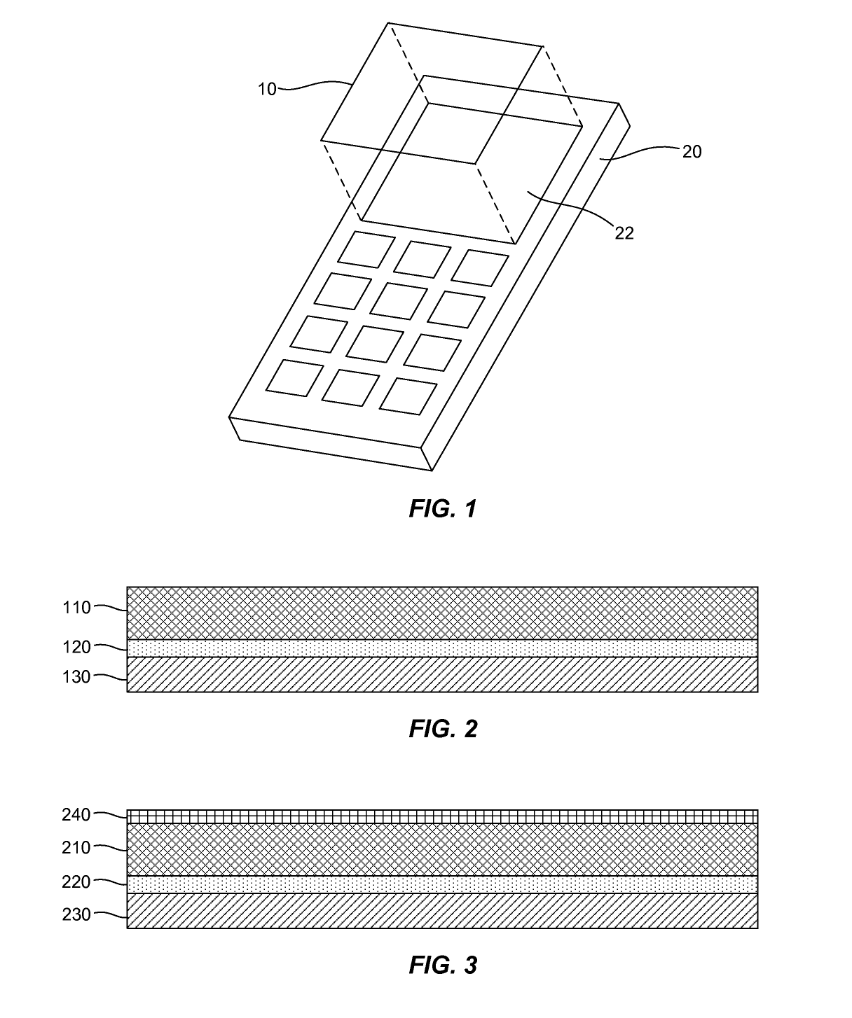

With reference to FIG. 1, illustrated are a protective film 10 and a device 20. The protective film 10 can be configured to shield or protect all or a portion of the device 20. For example, the protective film can be applied to a surface of a device, e.g., to protect the paint or finish against scratches or staining. In the figure, the protective film is configured to protect a screen 22 of the device 20. The device 20 can be a personal electronic device, a cell phone, a personal digital assistant, a camera, a laptop, a calculator, a digital music player, a digital movie player, etc. The device 20 can therefore include features such as a screen, a key, a keypad, a button, a switch, or any other device feature. Accordingly, any or all of such features can be protected by the protective film. The protective film can be provided in various shapes to conform to a variety of devices.

In one aspect, the protective film can be applied to a touch screen. In this case, the protective film can be configured to allow the touch screen to function normally despite the presence of the protective film between the screen and the user. Additionally, the protective film can be configured to allow visibility through the protective film. For example, the protective film can be optically clear to permit a user to see an image on a screen, key, or other feature of the device 20. In another aspect, the protective film can be configured to resist abrasions. Abrasion resistance can help maintain optical clarity of the protective film.

An adhesive can be disposed on a side of the protective film to bond or adhere the protective film to the device. The adhesive can be optically clear prior to application of the protective film on the device. Additionally, the adhesive can be optically clear when the protective film is applied to the device. In one aspect, the adhesive can be configured to allow the protective film to be removed and reapplied to the device. The removable aspect of the adhesive can allow the protective film to be repositioned on the device. For example, when initially applying the protective film to the device, the film may be out of alignment with the device. The removable adhesive can permit the film to be removed from the device and reapplied in a correct alignment. The adhesive can be configured to minimize or eliminate adhesive residue on the device after removal of the protective film. This can permit the adhesive to maintain optical clarity when the protective film is removed from the device and reapplied to the device. In a particular aspect, the protective film and adhesive can be configured to be “dry” applied to the device. A dry application can result in immediate optical clarity of the adhesive when applied to the device.

The protective film can be optically clear prior to application to the device. Additionally, the protective film can be optically clear following application to the device. In one aspect, the protective film can be configured such that the film remains free of deformation when removed from the device. In other words, the film can remain in a substantially original dimensional configuration once removed from the device. Stretching or other deformation of the protective film can compromise optical clarity of the film. Thus, by remaining undeformed when removed from the device, the protective film can maintain optical clarity when reapplied to the same or a different device, as long as debris and fingerprints are prevented from contacting the adhesive surface.

In one aspect, multiple protective films can be applied to a single device. For example, a first protective film can be applied to a screen of the device and a second protective film can be applied to a keypad of the device.

With reference to FIG. 2, illustrated is a protective film 110, in accordance with an example of the present disclosure. An adhesive 120 can be disposed on the protective film 110. In one aspect, the protective film 110 may be provided with a removable backing 130 that secures the protective film before the film is applied to a device. The backing 130 can cover the adhesive 120 of the protective film 110 to prevent undesired adhesion or so that the adhesive 120 does not become contaminated before application to a device. The backing 130 can be removed prior to applying the protective film 110 to a device.

In one aspect, the backing can include a cut out that can be separated from the protective film while a remaining portion of the backing remains coupled to the protective film. The cut out can allow a user to peel off a portion of the backing to expose the adhesive section of the protective film that was covered by the cut out. In other words, the cut out can allow a portion of the backing to be removed from the protective film while maintaining a remaining portion of the backing on the protective film. For example, a smaller portion of the backing can be removed to expose adhesive of a first portion of the protective film. The first portion of the protective film can be disposed on or applied to a device. By exposing only a portion of the adhesive, the remaining portion of the backing can enable a user to more easily position or align the protective film before application to the device. When aligned, the remaining portion of the backing can then be removed to exposed adhesive of the remaining portion of the protective film for application to the device. Although the backing may be cut to form a cut out, the film itself may not be cut or marked. In some examples, the backing is cut independently of the protective film in order to avoid cutting or marking of the protective film during the manufacturing process.

Some desirable characteristics that may be exhibited by the protective film 110 include elasticity, optical clarity, oil and grease resistance, abrasion resistance, high shear strength, and low-temperature performance. In one aspect, the protective film can have a high surface hardness (e.g., around 3H pencil hardness), which can make the film impact resistant and well suited for surface protection of the device.

In some cases, the protective film can be applied to complex geometries and/or curved surfaces. These applications can benefit from a highly conformable, flexible plastic film. Such a film can be highly conformable and flexible and, at the same time, resistant to stretching or other deformation when removed and repositioned on the device. The protective film can comprise, for example, urethane, polyurethane, thermoplastic polyurethane, aliphatic thermoplastic polyurethane, polyvinyl chloride, chlorinated polymer, polyolefin, polyester, polyethylene terephthalate, polyamide, polyacrylate, polysilicone, etc. In a specific aspect, a thickness of the protective film is between about 0.002 inch and about 0.030 inch.

The adhesive 120 can be configured to be removable from the device while adhering to the protective film. In one aspect, a removable adhesive can be designed to form a bond that can be removed after several minutes to allow repositioning of the protective film. In another aspect, a removable adhesive can be designed to form a bond that can be removed after months or years to allow repositioning of the protective film or replacement of the film. The removable adhesive can be removed without leaving residue on the device and can be designed for repeated applications to the device while still providing adequate bonding strength to the device. In a specific aspect, the adhesive 120 can comprise a single layer or multiple layers of adhesive that can be of the same or a different composition. Adhesive materials can include polymers designed and formulated to exhibit the requisite viscoelastic properties resulting in a desired balance of tack, peel adhesion, and shear holding power. In a particular aspect, the adhesive can be formulated to be optically clear.

The adhesive can also exhibit adhesion to and clean removal from a wide variety of surfaces including metal, glass and polymeric substrates (i.e. plastics). Clean removability includes self-separating and hand peeling without leaving an adhesive residue. Thus, the adhesive composition displays removable adhesive characteristics to remove clean from device surfaces. This type of adhesive can include low temperature adhesives.

In one aspect, the adhesive can comprise a pressure sensitive adhesive that is suitably removable. A pressure sensitive adhesive can comprise acrylic based polymers, acrylic emulsion polymers, natural elastomeric polymers, synthetic elastomeric polymers, elastomeric copolymer microspheres, vinyl ethers, silicone, or combinations thereof. Suitable pressure sensitive adhesive materials can contain, for example, a polymer as a principal constituent, such as acrylic type polymers, block copolymers, natural or recovered rubbers, styrene butadiene rubbers, ethylene and vinyl acetate random copolymers, ethylene vinyl acrylic terpolymers, polyisobutylene poly(vinyl ethers), etc. In a specific aspect, elastomers used in the adhesive can be based on acrylics, butyl rubber, ethylene-vinyl acetate, natural rubber, nitriles, silicone rubber, styrene block copolymers, styrene-butadiene-styrene, styrene-ethylene/butylene-styrene, styrene-ethylene/propylene, styrene-isoprene-styrene, vinyl ethers, etc. Useful elastomeric polymers that may be incorporated in the adhesive include natural rubber (polyisoprene), polybutadiene, synthetic polyisoprene, random styrenebutadiene polymers, styrene-butadiene block copolymers, multiarmed and repeating (SB) copolymers, styrene-butadiene-styrene block copolymers, styreneisoprene block copolymers, styrene-isoprene-styrene block copolymers, multiarmed styrene-isoprene, block copolymers, and the like. Other elastomers, such as the ethylene-propylene diene rubbers, styrene-ethylene/butylene, styrene block copolymers, styrene-ethylene/propylene-styrene block copolymers, and the like may also be used.

In addition to the aforementioned materials, other materials can be present in the adhesive to impart desired properties. For example, plasticizers, antioxidants, filler materials, and/or pigments can also be included in the adhesive compositions. Cutting agents such as waxes and surfactants also can be included in the adhesives. Light stabilizers, heat stabilizers, and UV absorbers or blockers also can be included in the adhesive compositions. Ultraviolet absorbers include benzo-triazol derivatives, hydroxy benzyl phenones, esters of benzoic acids, oxalic acid, diamides, etc. Light stabilizers include hindered amine light stabilizers, and the heat stabilizers include dithiocarbamate compositions such as zinc dibutyl dithiocarbamate, although other stabilizers may be suitable. The adhesive materials can contain a mixture of solid tackifying resins and liquid tackifying resins. In a particular aspect, a pressure sensitive adhesive can be based on an elastomer compounded with a suitable tackifier (e.g., a rosin ester).

The pressure sensitive adhesive can be applied to the film by using standard coating techniques, such as curtain coating, gravure coating, reverse gravure printing, offset gravure printing, roller coating printing, brushing, knife-over-roll coating, air-brush roller coating, metering-roller coating, reverse roll coating, roller coating with bottom-action doctor blade, immersion, jet coating, spraying and the like.

With reference to FIG. 3, illustrated is a protective film 210, in accordance with another example of the present disclosure. As with the protective film illustrated in FIG. 2, an adhesive 220 can be disposed on the protective film 210 and a backing 230 can cover the adhesive. Additionally, the protective film 210 can include a coating or surface treatment 240.

In one aspect, the surface treatment 240 can be applied to the protective film 210, such as by gravure coating, spray, flexography, slot die coating, roll coating or other suitable methods. Optionally, the surface coating can be obtained by laser ablation, surface plasma, or other surface modifications. The surface treatment 240 can improve optical clarity due to smoothing of the protective film surface by the treatment materials. Additionally, the surface treatment 240 can improve chemical resistance, such as resistance to oil, grease, ink, or other chemicals. In one aspect, the surface treatment 240 can be flexible and conformable along with the protective film 210. In another aspect, the surface treatment 240 can be infused into the protective film 210.

Commercially available examples of suitable protective films include Avery Dennison PPF CH028 paint protection film and Haartz DefenZall™ PPF paint protection film. These protective films are typically commercially provided with the adhesive and removable backing in place. The Avery film is an optically clear urethane film with a proprietary pressure sensitive adhesive layer. The urethane film is also nanofusion treated. The Haartz film is a 0.006″ aliphatic TPU with an outer topcoat layer, a 0.002″ acrylic adhesive layer, and a bleached kraft release liner.

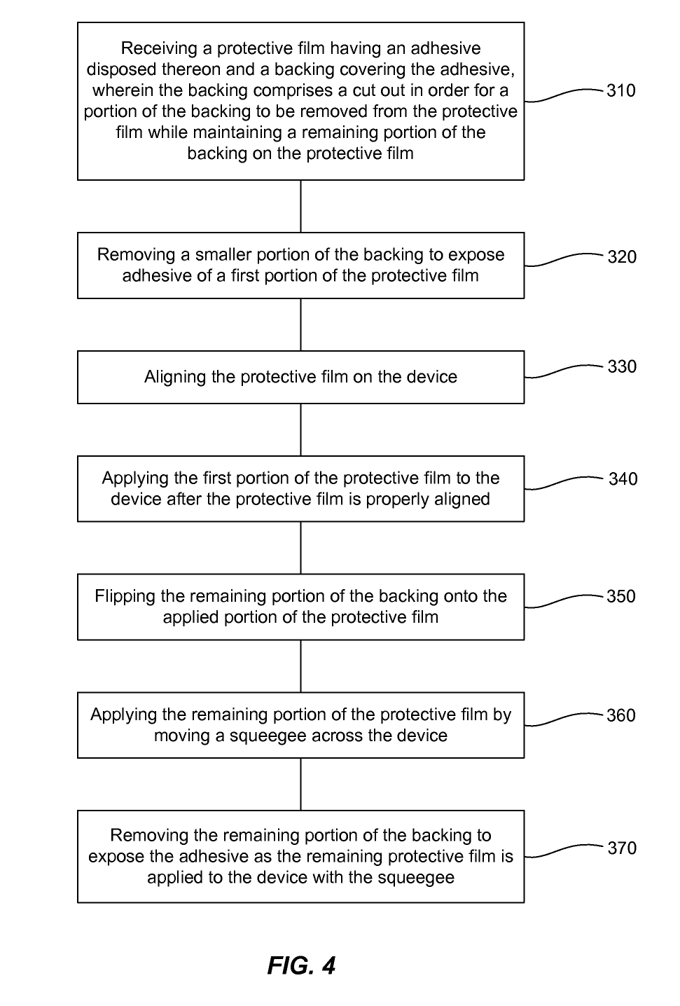

With reference to FIG. 4, shown is a block diagram illustrating a method for applying protective film to a device. For example, the method can comprise receiving a protective film having an adhesive disposed thereon and a backing covering the adhesive, wherein the backing comprises a cut out in order for a portion of the backing to be removed from the protective film while maintaining a remaining portion of the backing on the protective film 310. The method can also comprise removing a smaller portion of the backing to expose adhesive of a first portion of the protective film 320. The method can further comprise aligning the protective film on the device 330. Still further, the method can comprise applying the first portion of the protective film to the device after the protective film is properly aligned 340. Additionally, the method can comprise flipping the remaining portion of the backing onto the applied portion of the protective film 350. The method can also comprise applying the remaining portion of the protective film by moving a squeegee across the device 360. The method can further comprise removing the remaining portion of the backing to expose the adhesive as the remaining protective film is applied to the device with the squeegee 370. In one aspect, the method for applying protective film to a device can further comprise removing the protective film from the device. In another aspect, the method can further comprise realigning the protective film on the device and reapplying the protective film to the device. It is noted that no specific order is required in this method, though generally in one embodiment, these method steps can be carried out sequentially.

Before application of the protective film, the electronic device may be turned off and thoroughly cleaned. Typically, all dust, dirt, and other contaminants should be removed from the device before installation so that no contaminants are trapped between the protective film and the device. A user applying the protective film may also wash his or her hands to ensure that fingerprints are not left on the device or protective film during installation.

The user may remove the cut out portion of the backing by peeling it away. When the adhesive portion of the protective film that was covered by the cut out is exposed, the user should avoid touching the adhesive portion as well as avoid any other contaminants from coming into contact with the exposed adhesive portion. If contaminants come into contact with the exposed adhesive portion of the protective film it may be difficult to remove the contaminant as it may stick to the adhesive.

The protective film can have aligning key reference points to assist the user in properly aligning the protective film on the device. When the protective film is aligned correctly, the user can secure the exposed part of the protective film to the device by rubbing the exposed part with his or her fingers and using a squeegee. The squeegee can comprise a card that can be provided with the product. As the user secures the protective film, the user can work out any bubbles that may be trapped between the protective film and device by pushing the bubbles to the edge using the squeegee or fingers. For example, the squeegee can be used to press the film to the device surface with firm, overlapping strokes, making sure accurate alignment is maintained. Use of the squeegee can be repeated until all air is removed from beneath the protective film and proper edge bonding is achieved. If the exposed part of the protective film is not aligned properly, the user may peel it off the device and try to align it once again. Typically, the protective film is properly aligned before the user begins use of the squeegee to secure the exposed part to the device.

When the exposed portion of the protective film is secure, the remaining portion that is still secured to the backing can be flipped onto itself so the backing is facing up. The user can place the squeegee inside the bend created by flipping the protective film onto itself and apply pressure to the protective film. As the user applies pressure he may move the squeegee slowly forward along the device in order to apply the remaining portion of the protective film. The remaining portion of the backing will begin to separate from the protective film as the film is applied to the device. Use of the squeegee can prevent bubbles from forming as the protective film is applied. As the user slowly applies the remaining portion of the protective film, the user can simultaneously remove the backing portion until the protective film is fully adhered to the device.

When the protective film is applied, the user can use the squeegee to remove any bubbles between the protective film and the device by working the bubbles out to the sides of the device. Bubbles that are difficult to remove may settle and remove on their own within several hours to several days of applying the protective film.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

More specifically, while illustrative exemplary embodiments of the invention have been described herein, the present invention is not limited to these embodiments, but includes any and all embodiments having modifications, omissions, combinations (e.g., of aspects across various embodiments), adaptations and/or alterations as would be appreciated by those skilled in the art based on the foregoing detailed description. The limitations in the claims are to be interpreted broadly based on the language employed in the claims and not limited to examples described in the foregoing detailed description or during the prosecution of the application, which examples are to be construed as non-exclusive. Any steps recited in any method or process claims may be executed in any order and are not limited to the order presented in the claims. Accordingly, the scope of the invention should be determined solely by the appended claims and their legal equivalents, rather than by the descriptions and examples given above.

What is claimed is:

1. A method for applying protective film to a device, the method comprising:
receiving a protective film having an adhesive disposed thereon and a backing covering the adhesive, wherein the backing comprises a cut out in order for a portion of the backing to be removed from the protective film while maintaining a remaining portion of the backing on the protective film;
removing a smaller portion of the backing to expose adhesive of a first portion of the protective film;
aligning the protective film on the device;
applying the first portion of the protective film to the device after the protective film is properly aligned;
flipping the remaining portion of the backing onto the applied portion of the protective film;
applying the remaining portion of the protective film by moving a squeegee across the device; and
removing the remaining portion of the backing to expose the adhesive as the remaining protective film is applied to the device with the squeegee.

2. The method of claim 1, wherein the protective film comprises urethane, polyurethane, polyvinyl chloride, optically clear chlorinated polymer, polyester, polyethylene terephthalate, or combinations thereof.

3. The method of claim 1, wherein the protective film is optically clear prior to application to the device.

4. The method of claim 1, wherein the protective film is optically clear following application to the device.

5. The method of claim 1, further comprising removing the protective film from the device.

6. The method of claim 5, wherein the protective film is without deformation following removal from the device.

7. The method of claim 5, wherein no adhesive residue remains on the device.

8. The method of claim 5, further comprising:
realigning the protective film on the device; and
reapplying the protective film to the device.

9. The method of claim 8, wherein the protective film is optically clear following reapplication to the device.

10. The method of claim 1, wherein the adhesive comprises a pressure sensitive adhesive.

11. The method of claim 1, wherein the adhesive comprises acrylic based polymers, acrylic emulsion polymers, natural elastomeric polymers, synthetic elastomeric polymers, elastomeric copolymer microspheres, or combinations thereof.

12. The method of claim 1, wherein the device comprises personal electronic device, a cell phone, a personal digital assistant, a camera, a laptop, a calculator, a digital music player, or a digital movie player.
